(19) United States
(12) Patent Application Publication
(10) Pub. No.: US 2019/0275558 A1
(43) Pub. Date: Sep. 12, 2019

(54) LIQUID MIXTURE SUPPLYING DEVICE

(71) Applicant: ADVANFLO TECHNOLOGIES CO., LTD., New Taipei City (TW)

(72) Inventor: CHUN-MING LAI, New Taipei City (TW)

(73) Assignee: ADVANFLO TECHNOLOGIES CO., LTD., New Taipei City (TW)

(21) Appl. No.: 15/917,821

(22) Filed: Mar. 11, 2018

(51) Int. Cl. B05C 19/06; B05B 9/047; B05B 15/20; B01F 3/12; B01F 15/02; B01F 9/10

(52) U.S. Cl. CPC B05C 19/06; B05B 9/047; B05B 15/20; B01F 2009/0065; B01F 15/028; B01F 9/103; B01F 3/12

(57) ABSTRACT

A liquid mixture supplying device is provided for mixing a liquid mixture of a liquid and a powder and supplying the liquid mixture to a spray valve for spraying. The device has a structural design consisting of a containing vessel, a driving device, a dip tube and a scraper. The containing vessel is provided for storing the liquid mixture, and the driving device drives the containing vessel to rotate while a scraper disposed on a side of a dip tube is being used for distributing the liquid mixture. The containing vessel is installed in a tiltable external cavity, and a flow barrier is formed on an inner wall of the containing vessel, and the driving device drives the containing vessel to move by a magnetic force or a transmission shaft, so as to achieve the effect of uniform mixing.

### BACKGROUND OF THE INVENTION

### Field of the Invention

The present invention relates to a liquid mixture supplying device, in particular to the liquid mixture supplying device capable of automatically mixing a liquid mixture consisting of a spray adhesive for dispensing or a liquid and a powder and supplying the liquid mixture to a spray valve for spraying.

### Description of Related Art

Present LED packaging materials or electromagnetic wave shielding materials are liquid mixtures. For example, the liquid mixture consisting of an LED phosphor mixed adhesive material and a dilution is generally used as the LED packaging material, and the liquid mixture consisting of a metal powder mixed adhesive material and a dilution is generally used as the electromagnetic wave shielding material. The aforementioned liquid mixtures are sprayed on an object by a spraying process, and the spraying device used in the spraying process comprises a plurality of peripherals such as a storage cylinder, a motor-blade mixer installed onto the storage cylinder, a liquid nozzle, etc. The storage cylinder is pressurized to flow the liquid mixture stored in the storage cylinder to the liquid nozzle, so that the liquid nozzle can spray the liquid mixture onto the object.

The storage cylinder is a main device for storing the liquid mixture. Since the liquid mixture consisting of a liquid and a powder is usually in a flowable state, the liquid mixture is generally stratified after sitting still for a while, the mixture of the solid powder (which is a material with a larger specific gravity) sinks, and the material with a smaller specific gravity flows, therefore it is necessary to use the motor-blade mixer to stir the fluid continuously in order to maintain a uniform mixing condition and spray the liquid mixture uniformly from a liquid nozzle. However, external foreign substances may enter into the packaging material of the conventional spraying device with a motor-blade mixer easily, and thus contaminating the composition of the packaging material or clogging the nozzle, and affecting the quality of the spraying process and products. Therefore, it is a main subject for related manufacturers to design and develop a liquid mixture supplying device capable of automatically and uniformly mixing a liquid mixture of an adhesive for dispensing or a liquid and a powder, and supplying the liquid mixture to a spray valve for spraying.

### SUMMARY OF THE INVENTION

In view of the aforementioned drawbacks of the prior art, the inventor of the present invention based on years of experience in the related industry to conduct extensive researches and experiments, and finally developed a liquid mixture supplying device to overcome the drawbacks of the prior art.

It is a primary objective of the present invention to provide a liquid mixture supplying device having a structural design consisting of a containing vessel, a driving device, a dip tube and a scraper. The containing vessel is provided for storing the liquid mixture, and the driving device drives the containing vessel to rotate while a scraper disposed on a side of a dip tube is being used for distributing the liquid mixture, so as to achieve the effect of uniform mixing.

A secondary objective of the present invention is to provide a liquid mixture supplying device with the containing vessel installed in a tiltable external cavity, and the tilt action of the external cavity is provided for producing a change of gravity of the liquid mixture in the containing vessel to improve the uniform mixing effect.

Another objective of the present invention is to provide a liquid mixture supplying device capable of achieving the effect of driving the containing vessel to rotate by a driving device through the action of a magnetic force or a mechanical transmission shaft.

A further objective of the present invention is to provide a liquid mixture supplying device with a structure capable of distributing the mixing process at the inner wall of the containing vessel to improve the uniform fixing effect.

To achieve the aforementioned and other objectives, the present invention provides a liquid mixture supplying device for mixing a liquid mixture consisting of a liquid and a powder, and the liquid mixture supplying device preferably comprises: a containing vessel, for containing the liquid mixture, and capable of rotating about an axis; a driving device, for driving the containing vessel and capable of rotating along the axis; a dip tube, with an end extending into the containing vessel and the other end extending out of the containing vessel, and the driving device being coupled to a spray valve through a delivery tube.

Preferably, the liquid mixture supplying device further comprises a scraper combined to an external side of the dip tube and disposed at a position inside the containing vessel for mixing and distributing the liquid mixture; and an upright external cavity, having an upper chamber and a lower chamber, and the containing vessel is rotatably installed in the upper chamber, and the driving device is installed in the lower chamber.

Preferably, the liquid mixture supplying device further comprises an external cavity having an upper chamber and a lower chamber, and the containing vessel being rotatably installed in the upper chamber, and the driving device being installed in the lower chamber; and a base pivotally coupled to the external cavity, and the external cavity being capable of rotating on the base to adjust its angle for changing the center of gravity of the liquid mixture.

Preferably, the driving device of the aforementioned liquid mixture supplying device is rotated by pulling the containing vessel by a magnetic device.

Preferably, the magnetic device of the aforementioned liquid mixture supplying device comprises: a first kinetic coupling magnetic body, combined to a side of the containing vessel, for driving the containing vessel; a second kinetic coupling magnetic body, combined onto a rotating body of the driving device, and the second kinetic coupling magnetic body rotating with respect to the first kinetic coupling magnetic body to pull the first kinetic coupling magnetic body and the containing vessel for rotation.

Preferably, a transmission shaft is coupled between the driving device and the containing vessel of the aforementioned liquid mixture supplying device, and the transmission shaft passes between the upper chamber and the lower chamber, and the driving device drives the containing vessel to rotate through the transmission shaft.

Preferably, the aforementioned liquid mixture supplying device further comprises a base pivotally coupled to the external cavity, and the external cavity is capable of rotating on the base to adjust its angle.

Preferably, the aforementioned liquid mixture supplying device further comprises a bearing supported between the containing vessel and the upper chamber.

Preferably, more than one flow baffle are disposed on an inner wall of the containing vessel of the aforementioned liquid mixture supplying device, and the flow baffle are protrusions formed in a direction towards the axis.

Preferably, the aforementioned liquid mixture supplying device further comprises an air pressurization tube coupled to an air pressurization device, and the air pressurization device being provided for inputting a gas into the upper chamber through the air pressurization tube, so as to deliver the liquid mixture in the containing vessel to the spray valve.

In an application of the liquid mixture supplying device of the present invention, the driving device drives the containing vessel inside the external cavity to rotate. When the containing vessel rotates, the tilt action of the scraper, the flow barrier and/or the external cavity further mixes and distributes the liquid mixture, so that when the containing vessel rotates faster, a better mixing effect is achieved. When the containing vessel is operated in a tilted condition, a change of gravity is added to the mixing mechanism to improve the uniform mixing effect. In addition, the driving device may be driven by a magnetic coupling method or a direct-link driving of the transmission shaft, so that the containing vessel can rotate inside the external cavity.

### BRIEF DESCRIPTION OF THE DRAWINGS

FIG. 1 is a cross-sectional view of a liquid mixture supplying device in accordance with a first preferred embodiment of the present invention;

FIG. 2 of a schematic view showing the action of tilting a liquid mixture supplying device in accordance with the first preferred embodiment of the present invention; and

FIG. 3 is a cross-sectional view of a liquid mixture supplying device in accordance with a second preferred embodiment of the present invention.

### DESCRIPTION OF THE INVENTION

The aforementioned and other objects, characteristics and advantages of the present invention will become apparent with the detailed description of the preferred embodiments and the illustration of related drawings as follows.

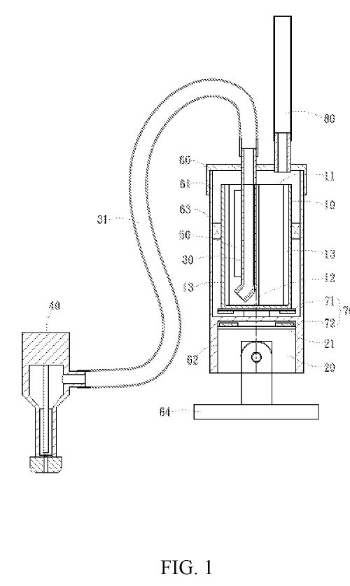

With reference to FIG. 1 for a liquid mixture supplying device of the present invention, the liquid mixture supplying device is used to mix a liquid mixture of a liquid and a powder and supply the liquid mixture to a spray valve for spraying. In a preferred embodiment, the liquid mixture supplying device comprises: a containing vessel 10, for containing the liquid mixture 100 (such as a liquid mixture of an adhesive of dispensing or a liquid and a powder), wherein the containing vessel is a cylindrical container having an opening 11 formed at the upper end of the containing vessel 10 as shown in the figure, and configured to be able to rotate about an axis 12; a driving device 20, preferably a driving motor installed under the containing vessel 10, for driving the containing vessel 10 to rotate about the axis 12; a dip tube 30, preferably a hard tube, wherein an end of the dip tube 30 is extended from the opening 11 at the upper end of the containing vessel 10 into the containing vessel 10, and the other end of the dip tube 30 is extended out of the containing vessel 10 and coupled to an external spray valve 40 through a delivery tube 31. Therefore, the driving device 20 can drive the containing vessel 10 to rotate about the axis 12, so as to achieve the effect of mixing the liquid mixture 100 in the containing vessel 10.

In a preferred embodiment of the present invention, the liquid mixture supplying device further comprises a scraper 50 which is a long strip or block combined with an external side of the dip tube 30 and disposed at a position in the containing vessel 10. When the containing vessel 10 is driven by the driving device 20 to rotate, the liquid mixture 100 in the containing vessel 10 can be mixed and distributed in an erect condition, so as to mix the liquid mixture 100 uniformly. In addition, an external cavity 60 may be an erect and untiltable drum, or a drum freely adjusted into a tilt condition. The external cavity 60 has an upper chamber 61 formed therein, and a lower chamber 62 disposed under the upper chamber 61. The containing vessel 10 is rotatably installed in the upper chamber 61, and supported between the containing vessel 10 and the upper chamber 61 by one or more bearings 63, so that the containing vessel 10 can reduce the friction of rotation, and the driving device 20 is installed in the lower chamber 62.

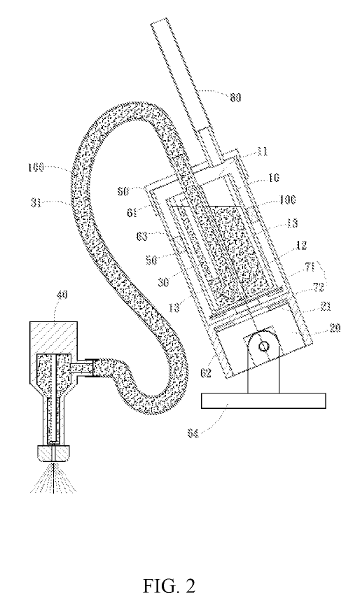

In FIG. 2, a change of gravity is provided to adjust the external cavity 60 into a tilt condition for an application, so that the containing vessel 10 achieves the function of mixing the liquid mixture 100. In another preferred embodiment of the present invention, the liquid mixture supplying device further comprises a base 64 pivotally coupled to the bottom of the external cavity 60, so that the external cavity 60 can rotate on the base 64 to adjust its angle (as shown in FIG. 2) to change the center of gravity of the liquid mixture 100. When the containing vessel 10 rotates faster, a better mixing effect is achieved. When the containing vessel 10 is operated in a tilt condition, the mixing mechanism is added with a change of gravity, so that the mixing effect is more significant.

In a preferred embodiment of the present invention as shown in FIGS. 1 and 2, the driving device 20 pulls the containing vessel 10 to rotate by a magnetic device 70 in order to let the driving device 20 (or driving motor) installed in the lower chamber 62 drive the containing vessel 10 in the upper chamber 61. Specifically, the magnetic device 70 comprises one or more first kinetic coupling magnetic bodies 71 (magnets) for fixing and combining the first kinetic coupling magnetic body 71 (magnet) with the bottom of the containing vessel 10 for driving the containing vessel 10; and one or more second kinetic coupling magnetic bodies 72, combined onto a rotating body 21 of the driving device 20, wherein the rotating body 21 is a circular disk driven by the driving motor, and the second kinetic coupling magnetic body 72 rotates with respect to the first kinetic coupling magnetic body 71, so that the first kinetic coupling magnetic body 71 and the containing vessel 10 can be pulled to rotate, and the liquid mixture 100 in the containing vessel 10 can be disturbed by the scraper 50 or rotated in a tilted condition, so as to achieve the uniform mixing effect. In the embodiment of using such magnetic device 70, the present invention can drive the containing vessel 10 to rotate with a spacing apart, so that the upper chamber 61 and the lower chamber 62 are totally separated to prevent any leakage of the liquid mixture 100 or the pressure pressurized in the upper chamber 61.

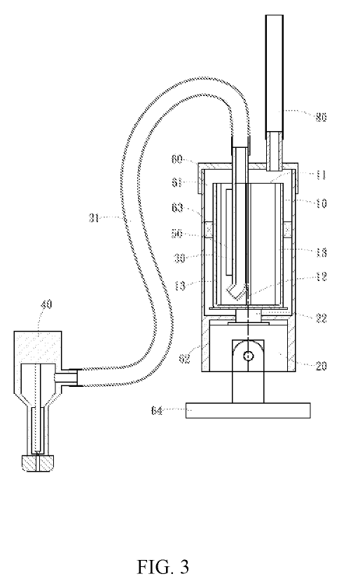

In the second preferred embodiment of the present invention as shown in FIG. 3, a transmission shaft 22 is passed and coupled between the driving device 20 and the containing vessel 10 to allow the driving device 20 installed in the lower chamber 62 to drive the containing vessel 10, and the transmission shaft 22 passes between the upper chamber 61 and the lower chamber 62, so that the driving device 20 can drive the containing vessel 10 to rotate by the transmission shaft 22, and the liquid mixture 100 can be disturbed by the scraper 50, or a uniform mixing effect can be achieved by the tilted rotation.

In FIG. 1 or 3, more than one flow baffle 13 are formed on an inner wall of the containing vessel 10 of the present invention. Four or more flow baffle 13 may be combined with the inner wall of the containing vessel 10 to form protrusions such as ribs or bumps in a direction towards the axis 12. When the containing vessel 10 rotates, the scraper 50 and the flow baffle 13 improve the disturbance of the liquid mixture 100. In addition, the upper chamber 61 may be coupled to an air pressurization tube 80, and the air pressurization tube 80 is coupled to an external air pressurization device (not shown in the figure), and the air pressurization device inputs the air through the air pressurization tube 80 into the upper chamber 61, so that the liquid mixture 100 in the containing vessel 10 is delivered through the dip tube 30 and the delivery tube 31 to the spray valve 40, so that the spray valve 40 can spray the liquid mixture 100.

While the invention has been described by means of specific embodiments, numerous modifications and variations could be made thereto by persons skilled in the art without departing from the scope and spirit of the invention set forth in the claims.

What is claimed is:

1. A liquid mixture supplying device, for mixing a liquid mixture of a liquid and a powder, comprising:
a containing vessel, for containing the liquid mixture, and capable of rotating about an axis;
a driving device, for driving the containing vessel to rotate about the axis; and
a dip tube, with an end extending into the containing vessel, and the other end extending out of the containing vessel, and coupled to a spray valve through a delivery tube.

2. The liquid mixture supplying device of claim 1, further comprising a scraper combined to an outer side of the dip tube and disposed at a position in the containing vessel for mixing and distributing the liquid mixture; and an upright external cavity, having an upper chamber and a lower chamber, and the containing vessel being rotatably installed in the upper chamber, and the driving device being installed in the lower chamber.

3. The liquid mixture supplying device of claim 2, further comprising an external cavity, having an upper chamber and a lower chamber, and the containing vessel being rotatably installed in the upper chamber, and the driving device being installed in the lower chamber; and a base, pivotally coupled to the external cavity, and the external cavity being capable of rotating on the base to adjust its angle, for changing the center of gravity of the liquid mixture.

4. The liquid mixture supplying device of claim 2, wherein the driving device drives the containing vessel to rotate by a magnetic device, and the magnetic device comprises a first kinetic coupling magnetic body combined to a side of the containing vessel for driving the containing vessel; and a second kinetic coupling magnetic body combined onto a rotating body of the driving device, and the second kinetic coupling magnetic body rotating with respect to the first kinetic coupling magnetic body and pulling the first kinetic coupling magnetic body and the containing vessel to rotate.

5. The liquid mixture supplying device of claim 3, wherein the driving device drives the containing vessel to rotate by a magnetic device, and the magnetic device comprises a first kinetic coupling magnetic body combined to a side of the containing vessel for driving the containing vessel; and a second kinetic coupling magnetic body combined onto a rotating body of the driving device, and the second kinetic coupling magnetic body rotating with respect to the first kinetic coupling magnetic body and pulling the first kinetic coupling magnetic body and the containing vessel to rotate.

6. The liquid mixture supplying device of claim 2, further comprising a transmission shaft coupled between the driving device and the containing vessel and passing between the upper chamber and the lower chamber, and the driving device driving the containing vessel to rotate through the transmission shaft.

7. The liquid mixture supplying device of claim 3, further comprising a transmission shaft coupled between the driving device and the containing vessel and passing between the upper chamber and the lower chamber, and the driving device driving the containing vessel to rotate through the transmission shaft.

8. The liquid mixture supplying device of claim 2, further comprising a bearing supported between the containing vessel and the upper chamber.

9. The liquid mixture supplying device of claim 3, further comprising a bearing supported between the containing vessel and the upper chamber.

10. The liquid mixture supplying device of claim 2, wherein the containing vessel has more than one flow baffle formed on an inner wall thereof, and the flow baffle are protrusions formed in a direction towards the axis.

11. The liquid mixture supplying device of claim 3, wherein the containing vessel has more than one flow baffle formed on an inner wall thereof, and the flow baffle are protrusions formed in a direction towards the axis.

12. The liquid mixture supplying device of claim 1, further comprising an air pressurization tube, and an air pressurization device coupled to the air pressurization tube for inputting a gas passing through the air pressurization tube into the upper chamber to deliver the liquid mixture in the containing vessel to the spray valve.
